(19) United States
(12) Patent Application Publication
(10) Pub. No.: US 2013/0247037 A1
(43) Pub. Date: Sep. 19, 2013

(54) CONTROL COMPUTER AND METHOD FOR INTEGRATING AVAILABLE COMPUTING RESOURCES OF PHYSICAL MACHINES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); KUAN-CHIAO PENG, New Taipei (TW); YEN-HUNG LIN, New Taipei (TW)

(73) Assignee: HON HAI PRECISION INDUSTRY CO., LTD., New Taipei (TW)

(21) Appl. No.: 13/756,559

(22) Filed: Feb. 1, 2013

(30) Foreign Application Priority Data
Mar. 15, 2012 (TW) 101108786

(51) Int. Cl. G06F 9/455

(52) U.S. Cl. CPC G06F 9/455
USPC 718/1

(57) ABSTRACT

In a method for integrating available computing resources of physical machines in a data center, a user request for installing a virtual machine in a data center and a specified amount of computing resources required by the virtual machine are received from a client computer. If there are no physical machine that satisfies the specified amount of computing resources and a total amount of available computing resources of the physical machines is equal to or greater than the specified amount, a resource collection strategy of the physical machines is set. The available computing resources of the physical machines are collected according to the resource collection strategy, virtual machines previously installed in one of the physical machines are transferred to other physical machines, and the virtual machine required by the client computer is deployed in the one of the physical machines.

### BACKGROUND

1. Technical Field

Embodiments of the present disclosure relate to virtual machine technology, and particularly to a control computer and method for integrating available computing resources of physical machines in a data center.

2. Description of Related Art

In cloud computing technology, a plurality of physical machines (e.g., servers) are included in a data center. Each physical machine can be installed with one or more virtual machines (VMs) for providing multiple services to users. Each virtual machine occupies certain computing resources such as CPU, memory, and hard disk resources of the physical machines. If available computing resources of individual physical machine are insufficient, a new virtual machine cannot be installed in the data center.

### BRIEF DESCRIPTION OF THE DRAWINGS

FIG. 1 is a schematic block diagram of one embodiment of an application of a control computer.

FIG. 2 is a block diagram of one embodiment of function modules of a resource integration system in FIG. 1.

FIG. 3 is a flowchart of one embodiment of a method for integrating available computing resources of physical machines in a data center using the control computer of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

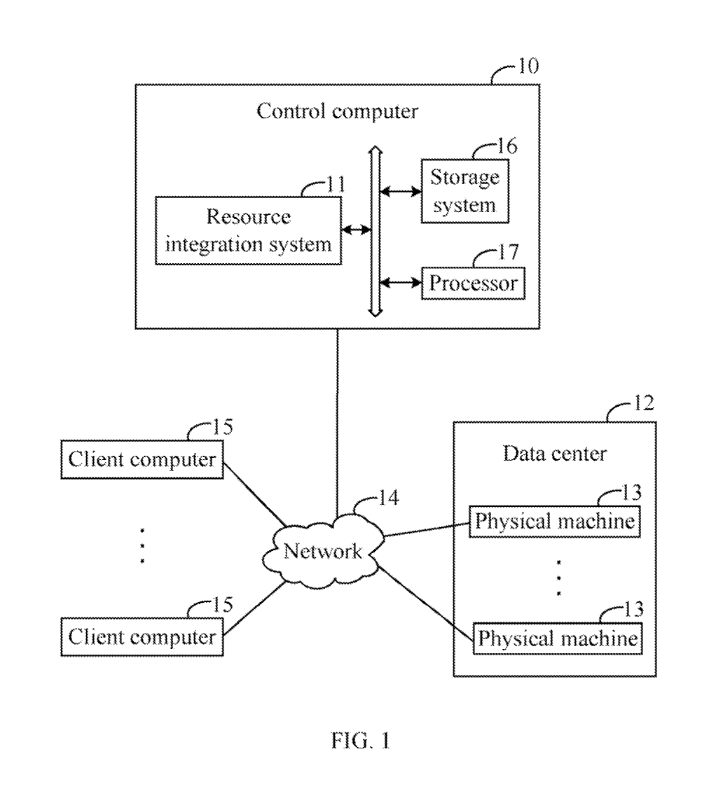

FIG. 1 is one embodiment of an application of a control computer 10. The control computer 10 is connected to a data center 12 through a network 14. The data center 12 includes a plurality of physical machines 13 such as servers, each of which can be installed with one or more virtual machines. A plurality of client computers 15 are connected to the data center 12 via the network 14 to use the virtual machines. The control computer 10 includes a resource integration system 11. The resource integration system 11 integrates available computing resources of the physical machines 13, so that new virtual machines can be installed in the data center 12. The network 14 may be a public or private network.

In this embodiment, the control computer 10 further includes a storage system 16 and at least one processor 17. The storage system 16 may be a dedicated memory, such as an EPROM, a hard disk drive (HDD), or flash memory. In some embodiments, the storage system 16 may be an external storage device, such as an external hard disk, a storage card, or a data storage medium.

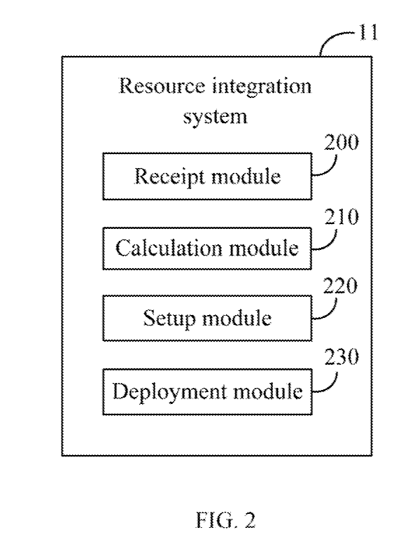

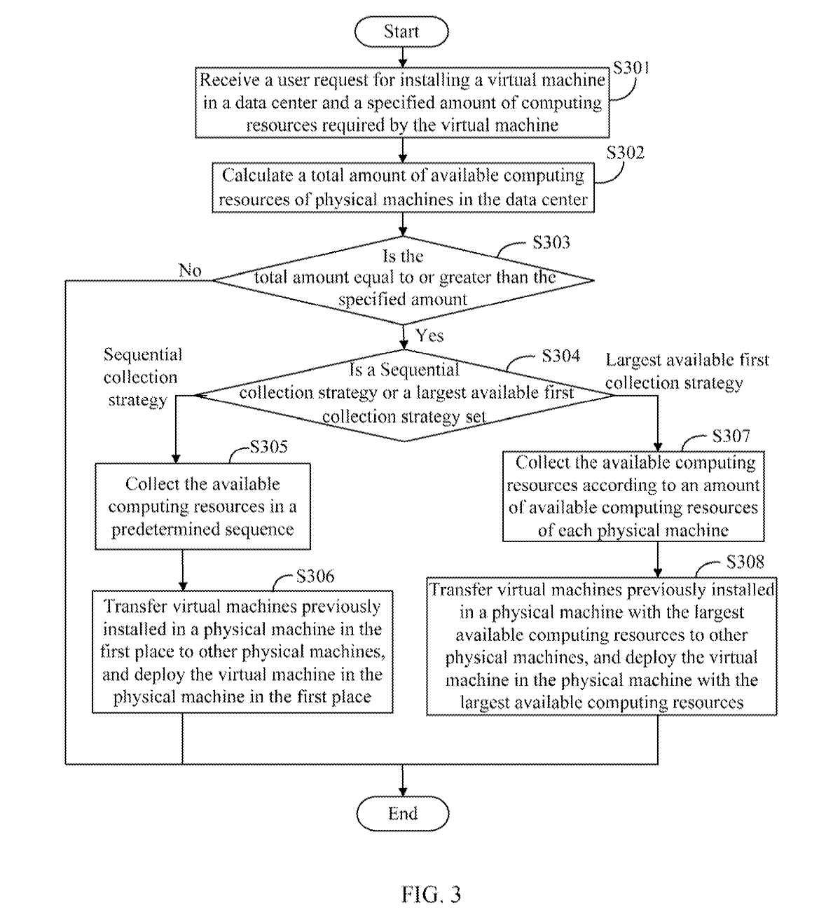

FIG. 2 is a block diagram of one embodiment of function modules of the resource integration system 11 in FIG. 1. The resource integration system 11 includes a receipt module 200, a calculation module 210, a setup module 220, and a deployment module 230. The modules 200-230 may comprise computerized code in the form of one or more programs that are stored in the storage system 16. The computerized code includes instructions that are executed by the at least one processor 17, to provide the aforementioned functions of the resource integration system 11. A detailed description of the functions of the modules 200-230 is given in reference to FIG. 3.

FIG. 3 is a flowchart of one embodiment of a method for integrating available computing resources of the physical machines 13 in the data center 12 using the control computer 10 of FIG. 1. Depending on the embodiment, additional steps may be added, others removed, and the ordering of the steps may be changed.

In step S301, the receipt module 200 receives a user request for installing a virtual machine in the data center 12 from a client computer 15, and receives a specified amount of computing resources required by the virtual machine. The computing resources required by the virtual machine may include CPU resource, memory resource, and hard disk resource. For example, the computing resources required by the virtual machine include three CPUs.

If there are no physical machine 13 that satisfies the specified amount of computing resources required by the virtual machine, in step S302, the calculation module 210 calculates a total amount of available computing resources of the physical machines 13. The calculation module 210 may compare the specified amount of computing resources required by the virtual machine with an amount of available computing resources of each of the physical machines 13, to determine whether there are any physical machines 13 satisfying the specified amount of computing resources required by the virtual machine. In one example, three physical machines 13 are included in the data center 12. Identifiers of the three physical machines 13 are Server1, Server2, and Server3 respectively. Server1 includes one available CPU. Server2 includes one available CPU. Server3 includes two available CPUs. If the virtual machine requires three CPUs, there are no physical machine 13 that satisfies the specified amount of computing resources required by the virtual machine. In this example, a total number of available CPUs of the three physical machines 13 is four.

In step S303, the calculation module 210 compares the total amount of available computing resources of the physical machines 13 with the specified amount of computing resources required by the virtual machine. If the total amount of available computing resources of the physical machines 13 is less than the specified amount of computing resources required by the virtual machine, the process ends.

If the total amount of available computing resources of the physical machines 13 is equal to or greater than the specified amount of computing resources required by the virtual machine, in step S304, the setup module 220 sets a resource collection strategy of the physical machines 13. In one embodiment, the resource collection strategy of the physical machines 13 includes a sequential collection strategy and a largest available first collection strategy. According to the sequential collection strategy, the available computing resources of the physical machines 13 are collected in a predetermined sequence. For example, the data center 12 includes three physical machines 13 Server1, Server2, and Server3. The available computing resources are first collected from Server1 and last collected from Server3. According to the largest available first collection strategy, the available computing resources are first collected from a physical machine 13 with the largest available computing resources.

If the sequential collection strategy is set, in step S305, the deployment module 230 collects the available computing resources of the physical machines 13 in the predetermined sequence, until an amount of the collected available computing resources is equal to or larger than the specified amount of computing resources required by the virtual machine. The sequence may be determined according to identifiers of the physical machines 13 (e.g. from Server1 to Server3).

In step S306, the deployment module 230 transfers virtual machines previously installed in a physical machine 13 in the first place of the predetermined sequence to other physical machines 13, and deploys the virtual machine required by the client computer 15 in the physical machine 13 in the first place of the predetermined sequence. Then the process ends. For example, three physical machines 13 Server1, Server2, and Server3 are included in the data center 12. The available computing resources are first collected from Server1 and last collected from Server3. Therefore, virtual machines previously installed in Server1 are transferred to Server2 and Server3, and the virtual machine required by the client computer 15 is deployed in Server1.

In step S304, if the largest available first collection strategy is set, in step S307, the deployment module 230 first collects the available computing resources from a physical machine 13 with the largest available computing resources, until the amount of the collected available computing resources is equal to or larger than the specified amount of computing resources required by the virtual machine.

In step S308, the deployment module 230 transfers virtual machines previously installed in the physical machine 13 with the largest available computing resources to other physical machines 13, and deploys the virtual machine required by the client computer 15 in the physical machine 13 with the largest available computing resources.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for integrating available computing resources of physical machines in a data center being executed by a processor of a control computer, the method comprising:
receiving a user request for installing a virtual machine in the data center from a client computer, and receiving a specified amount of computing resources required by the virtual machine;
calculating a total amount of available computing resources of the physical machines in response that there are no physical machine that satisfies the specified amount of computing resources required by the virtual machine;
setting a resource collection strategy of the physical machines in response that the total amount of available computing resources of the physical machines is equal to or greater than the specified amount of computing resources required by the virtual machine; and
collecting the available computing resources of the physical machines according to the resource collection strategy, transferring virtual machines previously installed in one of the physical machines to other physical machines, and deploying the virtual machine required by the client computer in the one of the physical machines.

2. The method of claim 1, wherein the resource collection strategy of the physical machines comprises a sequential collection strategy and a largest available first collection strategy.

3. The method of claim 2, wherein in response to the sequential collection strategy, the available computing resources of the physical machines are collected in a predetermined sequence, virtual machines previously installed in a physical machine in the first place of the predetermined sequence are transferred to other physical machines, and the virtual machine required by the client computer is deployed in the physical machine in the first place of the predetermined sequence.

4. The method of claim 2, wherein in response to the largest available first collection strategy, the available computing resources are first collected from a physical machine with the largest available computing resources, virtual machines previously installed in the physical machine with the largest available computing resources are transferred to other physical machines, and the virtual machine is deployed in the physical machine required by the client computer with the largest available computing resources.

5. The method of claim 1, wherein the computing resources required by the virtual machine comprise CPU resource, memory resource, and hard disk resource.

6. A control computer, comprising:
a storage system;
at least one processor; and
a resource integration system comprising one or more programs that are stored in the storage system and executed by the at least one processor, the one or more programs comprising instructions to:
receive a user request for installing a virtual machine in a data center connected to the control computer from a client computer, and receive a specified amount of computing resources required by the virtual machine;
calculate a total amount of available computing resources of physical machines in the data center in response that there are no physical machine that satisfies the specified amount of computing resources required by the virtual machine;
set a resource collection strategy of the physical machines in response that the total amount of available computing resources of the physical machines is equal to or greater than the specified amount of computing resources required by the virtual machine; and
collect the available computing resources of the physical machines according to the resource collection strategy, transfer virtual machines installed in one of the physical machines to other physical machines, and deploy the virtual machine in the one of the physical machines.

7. The control computer of claim 6, wherein the resource collection strategy of the physical machines comprises a sequential collection strategy and a largest available first collection strategy.

8. The control computer of claim 7, wherein in response to the sequential collection strategy, the available computing resources of the physical machines are collected in a predetermined sequence, virtual machines previously installed in a physical machine in the first place of the predetermined sequence are transferred to other physical machines, and the virtual machine required by the client computer is deployed in the physical machine in the first place of the predetermined sequence.

9. The control computer of claim 7, wherein in response to the largest available first collection strategy, the available computing resources are first collected from a physical machine with the largest available computing resources, virtual machines previously installed in the physical machine with the largest available computing resources are transferred to other physical machines, and the virtual machine is deployed in the physical machine required by the client computer with the largest available computing resources.

10. The control computer of claim 6, wherein the computing resources required by the virtual machine comprise CPU resource, memory resource, and hard disk resource.

11. A non-transitory storage medium storing a set of instructions, the set of instructions capable of being executed by a processor of a control computer to implement a method for deploying a virtual machine in a data center comprising a plurality of physical machines, the method comprising:
receiving a user request for installing a virtual machine in the data center from a client computer, and receiving a specified amount of computing resources required by the virtual machine;
calculating a total amount of available computing resources of the physical machines in response that there are no physical machine that satisfies the specified amount of computing resources required by the virtual machine;
setting a resource collection strategy of the physical machines in response that the total amount of available computing resources of the physical machines is equal to or greater than the specified amount of computing resources required by the virtual machine; and
collecting the available computing resources of the physical machines according to the resource collection strategy, transferring virtual machines installed in one of the physical machines to other physical machines, and deploying the virtual machine in the one of the physical machines.

12. The non-transitory storage medium of claim 11, wherein the resource collection strategy of the physical machines comprises a sequential collection strategy and a largest available first collection strategy.

13. The non-transitory storage medium of claim 12, wherein in response to the sequential collection strategy, the available computing resources of the physical machines are collected in a predetermined sequence, virtual machines previously installed in a physical machine in the first place of the predetermined sequence are transferred to other physical machines, and the virtual machine required by the client computer is deployed in the physical machine in the first place of the predetermined sequence.

14. The non-transitory storage medium of claim 12, wherein in response to the largest available first collection strategy, the available computing resources are first collected from a physical machine with the largest available computing resources, virtual machines previously installed in the physical machine with the largest available computing resources are transferred to other physical machines, and the virtual machine is deployed in the physical machine required by the client computer with the largest available computing resources.

15. The non-transitory storage medium of claim 11, wherein the computing resources required by the virtual machine comprise CPU resource, memory resource, and hard disk resource.
